(19) United States
(12) Patent Application Publication
(10) Pub. No.: US 2020/0011747 A1
(43) Pub. Date: Jan. 9, 2020

(54) Multi-Point Balanced Configuration Magnetometer

(71) Applicant: Methode Electronics Malta Ltd., Mriehel (MT)

(72) Inventors: Assed Mir, Halifax (GB); Ignazio Barraco, München (DE)

(21) Appl. No.: 16/502,367

(22) Filed: Jul. 3, 2019

(30) Foreign Application Priority Data
Jul. 9, 2018 (DE) 10 2018 116 595.1

(51) Int. Cl. G01L 1/12

(52) U.S. Cl. CPC G01L 1/125

(57) ABSTRACT

A magnetic field device determines external magnetic influence. The device has a component with ferromagnetic material. The component has one or more magnetizable tracks arranged adjacent to each other having opposing directions of magnetization and arranged axially in relation to the component. A first magnetic field sensor is arranged radially in relation to the component and is assigned to the two tracks. A second magnetic field sensor is arranged radially in relation to the component and is assignable to two magnetisable tracks. The signal of each of the magnetic field sensors is set in relation to the signal of the at least one another magnetic field sensor. The signals produced by the magnetic field sensors form at least one individual signal channel. The first and second magnetic field sensors are combined with each other axially along the direction of magnetization of the assigned magnetic track to form the signal channel.

### RELATED APPLICATION DATA

This application claims priority to German patent application ser. No. DE 10 2018 116 595.1 filed on Jul. 9, 2018, the disclosure of which is incorporated by reference herein.

### DESCRIPTION

This disclosure relates to a magnetoelastic sensor device for determining a magnetic influence due to an error, an interfering effect or other influences of a product, comprising a component which consists at least partially of ferromagnetic material, in particular a device which comprises two or more sensors for determining external magnetic influences.

### PRIOR ART

Such devices comprise among others at least one magnetoelastic sensor. An example of a magnetoelastic sensor is disclosed in the U.S. Pat. No. 9,347,845 B2.

A magneto elastic sensor has a longitudinally extending shaft like member which is subject to a load. A magneto-elastically active region is directly or indirectly attached to or forming a part of the member in such a manner that a mechanic stress is transmitted to the active region. A magnetically polarized region of the active region becomes increasingly helically shaped as the application stress increases. A magnetic field sensor is arranged approximate the magneto-elastically active region for outputting a signal corresponding to a stress induced magnetic flux emanating from the magnetically polarized region. The magnetic sensor determines one out of a shear stress and a compressive stress. The magnetic sensor can include at least one direction sensitive magnetic field sensor, which is arranged having a predetermined and fixed spatial coordination with the member.

According to the US 2016/0238472 A1 a device for determining an external magnetic influence, comprises a component which consists at least partially of ferromagnetic material. It further shows a magnetisable region comprising at least three magnetic tracks. Adjacent magnetic tracks of which are each magnetised in opposite directions of each other. The at least three magnetic tracks are arranged axially in relation to the component.

At least one coil of a first magnetic field sensor for emitting a signal arranged radially in relation to the component is assignable to the first outer and at least one middle magnetic track, respectively. At least one coil of a second magnetic field sensor for emitting a signal arranged radially in relation to the component is assignable to the at least one middle and second outer magnetic track, respectively.

The signal of the first sensor is set in relation to the signal of the second sensor.

Information is reached, which is the amount of or the difference between the fields across the magnetic track A and the magnetic track B and across the magnetic tracks B and C.

Because of the individual measurements made by individually connecting the channels the signals of output by the channels can be created as required.

With many of today's magnetic field sensors it is difficult to delete manufacturing tolerances of more than one component to be measured parallel and in a satisfactory manner.

Many modern magnetic field sensors do not extract errors that are created either by the tolerances of the measurement elements or by the geometry of the component.

Often current sensing elements show difficulties in mastering parallel channels covering a plurality of magnetic bands satisfactorily.

It proves difficult both to gather information to cancel the unwanted noise and collect information i.e. for warning purposes at the same time.

Commonly known magnetic field sensors do not deliver additional information, such as the amount of a near field or the difference between the magnetic fields across several magnetic tracks.

The measurement done by today's magnetic field sensors do not extract the noise or any magnetic field changes in the environment.

The patent application refers to a magnetic field sensor which can based on any technology such as flux gates, hall effect sensors, magneto resistive sensors etc. In the following the patent application refers to the sensor as a magnetic field sensor.

The US 2016/0238472 protects a prior invention of the applicant providing satisfying results in a vast number of technical applications.

However, in practice the calibration of near field noise and common mode fields does not meet all application requirements.

Still the implementation into practice has shown a number of improvements and further effects which led to the following objects of the present invention.

It is one object of the invention to provide a magnetoelastic sensor device wherein each channel can be calibrated individually, such that the channels are closely matched. Thus, it is an object of the invention to calibrate out near field noise, common mode fields as well as any unwanted noise signals.

A further aspect is to delete negative effects individually.

Another object of the invention is to effectively and reliably combine channel signals of a magnetoelastic sensor device to reject noise field effects. The noise field effect can derive from a common mode noise field.

It goes without saying that the source of the noise can also be any other noise field other than a common mode noise field.

Further, the magnetoelastic sensor device should provide a channel which can be calibrated to reject known near fields.

Another object of the invention is to provide a magnetoelastic sensor device, the coils of which can be split up and can be configured to form separate channels.

Yet another object of the invention is to create a magnetoelastic sensor device, wherein sensors can be further split so as to form separate channels.

Also the magnetoelastic sensor device should be capable to function with a tri-band application or more-band application and/or an application with two magnetic bands on the one hand. It should also be used with a single magnetic band on the other hand.

Thus, the magnetoelastic sensor device should be capable for measurements with any number of magnetic tracks and any number of magnetic field sensors and/or at least one associated coil.

It is another object of the invention to be capable to change the functionality of the sensor.

Related to that it is a further object of the invention to create a sensor providing a signal which can be automatically cleared off any unwanted negative effect.

According to another object of the invention a common mode cancellation of the sensor signal should be made possible, independent of any manufacturing tolerance of the component to be measured.

It is a further object of the invention to provide a sensor measuring the amount of the field strength of a common mode field and the amount of the field strength of a near field which is present in the sensor at the same time.

Additional embodiments may cover devices comprising any number of magnetic bands, sensors and/or coils.

According to another object of the invention the sensor provides information to cancel an unwanted noise present in the sensor and to gather information for warning purposes at the same time.

In US 2016/0238472, FIG. 4 shows a ferromagnetic component 1 having three magnetic tracks 155, 156 and 161 of a tri-band configuration. Said magnetic tracks 155, 156 and 161 are arranged adjacent to each other. The magnetic tracks 155, 156 and 161 comprise a center magnetic track 156. Adjacent at each side of said center magnetic track 156 there is arranged at least one outer magnetic track 155 and 161.

Each of the magnetic tracks 155, 156 and 161 have an opposite magnetization.

Each magnetic track 155, 156 and 161 communicates with at least one the magnetic field sensors 153, 154, 157, 163, 158, 159, 160 and 164.

Each channel has at least two coils (not shown).

The magnetic field sensor 153, 154, 157, 163, 158, 159, 160 and 164 are arranged at the outer circumference of the ferromagnetic component 1 and are positioned radially to the magneto-elastically active region that is the magnetic tracks 155, 156, 161.

The magnetic field sensor 153, 154, 157, 163, 158, 159, 160 and 164 determines any shear stress present in the component.

In US 2016/0238472 FIG. 4 at least two magnetic field sensors 153, 154, 157, 163, 158, 159, 160 and 164 and/or the corresponding coils of the magnetic field sensors 153, 154, 157, 163, 158, 159, 160 and 164 are axially connected with each other to form a channel Ch1, Ch2 in a dual-dual configuration.

The at least two magnetic field sensors 153, 154, 157, 163, 158, 159, 160 and 164 are connected with each other axially relative to the ferromagnetic component 1.

By way of an example, in FIG. 4 the sensors 153, 158, 154, 159 would form the channel Ch1. Whereas the sensors 160, 157 and 164, 163 would be connected with each other to form the second channel Ch2.

The device of US 2016/0238472 FIG. 4 uses the standard differential measurement to form the individual sensors of the channel Ch1 and of Ch2. The channel Ch1 is comprised of the magnetic field sensors 153, 158, 154, 159 and the channel Ch2 is comprised of magnetic field sensors 160, 157, 164 and 163 together the channels Ch1, Ch2 are combined in a dual-dual-band-configuration. Together they are linking the magnetic field sensors of channels Ch1, Ch2 axially relative to the ferromagnetic component 1.

The prior art tri-band-measurement of US 2016/0238472 FIG. 4 is formed by using the ellipse 168 combining the magnetic field sensors 153, 154, 158, 159. The ellipse 169 combines the magnetic field sensors 160, 164, 157 and 163).

US 2016/0238472 FIG. 4 shows that the combination of the magnetic field sensors 153, 158, 154 and 159 (ellipse 168) and magnetic field sensors 160, 164, 157 and 163 (ellipse 169) are part of a dual-dual-configuration of the magnetic tracks 155, 156, 161.

The magnetic field sensors 153, 158, 154 and 159 (ellipse 168) communicate with channel Ch1, whereas the magnetic field sensors 160, 164, 157 and 163 (ellipse 169) communicate with channel Ch2.

To form the channel Ch1 and Ch2 respectively, both in the ellipse 168 (channel Ch1) and in the ellipse 169 (channel Ch2) the magnetic field sensors 153, 154, 157, 163 and 158, 159, 160 and 164 are linked with each other in an axial manner, relative to the ferromagnetic component 1.

In the dual-dual band configuration of the magnetic tracks 155, 156, 161 shown in US 2016/0238472 FIG. 4 the center magnetic track 156 is referred to by both the channel Ch1 and the channel Ch2.

In other words, in the dual-dual configuration of US 2016/0238472 FIG. 4 the magnetic track 156 communicates with the magnetic field sensors 158, 159 referring to the channel Ch1. However, the magnetic track 156 communicates also with the magnetic field sensors 160, 164 referring to the channel Ch2.

The dual-dual configuration shown in US 2016/0238472 FIG. 4 comprises two channels Ch1 and Ch2 with the magnetic field sensors 153, 154, 158, 159 (channel Ch1) and the magnetic field sensors 160, 164, 157 and 163. The magnetic field sensors 160, 158, 159, 164 refer to two individual channels Ch1 and Ch2 each communicate with the same magnetic tracks 156.

The combined ellipse 168 and the ellipse 169 each represent an individual Ch1 (ellipse 168) and Ch2 (ellipse 169).

Thus, in US 2016/0238472 FIG. 4, there are two individual ellipses 168, 169. Each ellipse 168, 169 represents one individual measurement represented by the individual channel Ch1 and Ch2, respectively. The outcome of the measurement would be one signal of one channel.

When the combined signals of the dual-dual-option which is the ellipse 168 and the ellipse 169 are added up the output is exactly the same as the output of the ellipse 170 of US 2016/0238472 FIG. 5.

US 2016/0238472 FIG. 5 shows a ferromagnetic component 1 having three magnetic tracks 155, 156 and 161 of a tri-band configuration. Said magnetic tracks 155, 156 and 161 are arranged adjacent to each other. The magnetic tracks 155, 156 and 161 comprise a center magnetic track 156. Adjacent at each side of said center magnetic track 156 there is arranged at least one outer magnetic track 155 and 161.

Each of the magnetic tracks 155, 156 and 161 has an opposite magnetization.

Each magnetic track 155, 156 and 161 communicates with at least one the magnetic field sensor 153, 154, 157, 163, 158, 159, 160 and 164.

Each channel has at least two coils (not shown).

The magnetic field sensor 153, 154, 157, 163, 158, 159, 160 and 164 are arranged at the outer circumference of the ferromagnetic component 1 and are positioned radially to the magneto-elastically active region that is the magnetic tracks 155, 156, 161.

The magnetic field sensor 153, 154, 157, 163, 158, 159, 160 and 164 determines any shear stress present in the component.

Contrary to US 2016/0238472 FIG. 4, in US 2016/0238472 FIG. 5, the magnetic field sensors 153, 154, 157, 163, 158, 159, 160 and 164 and/or the corresponding coils of the magnetic field sensors 153, 154, 157, 163, 158, 159, 160 and 164 are axially connected with each other—relative to the ferromagnetic component—to form one single channel Ch1.

US 2016/0238472 FIG. 5 shows the standard differential measurement to form the individual magnetic field sensors 153, 154, 157, 163, 158, 159, 160 and 164 and/or the corresponding coils of the magnetic field sensors 153, 154, 157, 163, 158, 159, 160 and 164 of the channel Ch1 individually.

The eight magnetic field sensors 153, 154, 157, 163 and 158, 159, 160 and 164 including the corresponding coils shown in US 2016/0238472 FIG. 5 are part of the ellipse 170 to form a tri-band configuration of the magnetic tracks 155, 156, 161.

In the ellipse 170 the magnetic field sensors 153, 154, 157, 163 and 158, 159, 160 and 164 including the corresponding coils however are covered by one measurement. The outcome of the measurement would be one signal of one channel.

The magnetic field sensors 153, 154, 157, 163 and 158, 159, 160 and 164 including the corresponding coils represent one single channel Ch1. The magnetic field sensors 153, 154, 157, 163 and 158, 159, 160 and 164 of the channel Ch1 however, are divided into groups of two magnetic field sensors. Thus each group of the magnetic field sensors 153, 154, 157, 163 and 158, 159, 160 and 164 of the channel Ch1 refers to one individual magnetic track 155, 156 and 161.

The individual magnetic track 155 is associated to the magnetic field sensors 153, 154 whereas the individual magnetic track 161 is associated to the magnetic field sensors 157, 163. The center magnetic track 156 refers to the two groups of magnetic field sensors 158, 159 and 160, 164.

### SUMMARY

The device of the present disclosure differentiates over the devices of the prior art, by providing measurement on individual magnetic track. The magnetic track can also be referred to as magnetisable track or magnetic band. The following three options are examples of a plurality of further versions where the sensor can be decomposed into multiple single sensing element.

In the following the wording “sensing element” refers to a “sensor”, such as a magnetic field sensor and the associated “coil”:

1. Option:

The first option refers to two Channels Ch1, Ch2 shown in FIG. 1. The first channel Ch1 refers to one magnetic track 155 and the second channel Ch2 refers to the magnetic track 156.

2. Option:

The second option refers to FIG. 2 with three channels Ch1, Ch2, Ch3. The first channel Ch1 is linked with the magnetic track 155 whereas the second channel Ch2 is linked with the magnetic track 156. The channel Ch3 communicates with the magnetic track 161.

3. Option:

The third option shows the combining similarly polarized magnetic tracks as individual channels. For example in FIG. 3 sensing elements would be 153, 157, 154 and 163 comprise one channel on magnetic tracks 155 and 161 and the second channel comprises 160, 158, 159 and 164 on magnetic track 156.

The summary of the invention is described as follows:

Magnetoelastic Sensor Device:

The magnetoelastic sensor device comprises at least two individual channels. Each of the channels has at least one magnetic field sensor.

In particular, the magnetoelastic sensor device shows a first embodiment comprising a “two channel two point dual-band balanced sensor”, wherein a second embodiment comprises a “three channel two point tri-band balanced sensor”. A third embodiment comprises a “two channel two point tri-band balanced sensor”. However, it is made clear that the magnetoelastic sensor device is not restricted to these embodiments; since a part of the figures of US 2016/0238472 show a visual similarity with figures of the present disclosure, the present disclosure can be described more clearly when highlighting the differences with regard to that of the prior art. Thus, the closest prior art is described at first with reference to FIG. 4.

The magnetoelastic sensor device refers to at least one individual magnetic track arranged on a ferromagnetic component. A synonym of the expression track is the expression band, also used in this description.

The ferromagnetic component is a longitudinally extending shaft like member. The ferromagnetic component is subject to a load introducing mechanic stress in the member.

At least one magneto-elastically active region is directly or indirectly connected to or forms a part of the member. Thus, the mechanic stress is transmitted to the magneto-elastically active region of the magnetoelastic sensor device.

Preferably said active region comprises at least one magnetically polarized region such that the polarization becomes increasingly active as the applied stress increases.

At least one magnetic field sensor is arranged approximate to the at least one magneto-elastically active region. The magnetic field sensor outputs a signal corresponding to a stress-induced magnetic flux emanating from the magnetically polarized region.

The magnetic field sensor comprises a direction sensitive magnetic field sensor. The magnetic field sensor is configured for determination of at least one out of a shear stress and/or a compressive stress.

Also, the magnetic field sensor is arranged to have a predetermined and fixed spatial coordination with the member that is the ferromagnetic component.

Said ferromagnetic component is preferably an at least partially hollow shaft, wherein functionally related to a multitude of magnetic field sensors of the magnetic sensor that are arranged at a radial circumference and are spaced relative to the ferromagnetic component.

Functionality of the Invention:

The functionality and the differences over the prior art are shown and described with reference to FIGS. 1-3 and FIG. 6.

To form the signal channel, the first magnetic field sensor and the second magnetic field sensor are combined with each other axially along the direction of magnetization of the assigned magnetic track.

Also to form the signal channel, the corresponding coils of said first magnetic field sensor and of the second magnetic field sensor are combined with each other axially along the direction of magnetization of the assigned magnetic track.

Further, to form the signal channel, any sensing element comprising the magnetic field sensor and/or the corresponding coil are combined with each other axially along the direction of magnetization of the assigned magnetic track.

The magnetic field sensors and/or the corresponding coils for each individual signal channel are positioned radially relative to the component.

The magnetic field sensors and/or the corresponding coils for each individual signal channel are positioned in the proximity of the component.

The channels Ch1, Ch2, Ch3 comprise at least one magnetic field sensor 153, 154, 157, 158, 159, 160, 163, 164, wherein the magnetic field sensors 153, 154, 157, 158, 159, 160, 163, 164 comprise at least one coil.

To generate a signal the magnetic field sensors 153, 154, 157, 158, 159, 160, 163, 164 and/or the coils of the magnetic field sensors 153, 154, 157, 158, 159, 160, 163, 164 communicate with at least one magnetic track 155, 156, 161.

To form the channels Ch1, Ch2, Ch3 the magnetic field sensors 153, 154, 157, 158, 159, 160, 163, 164 and/or its coils communicate with the magnetic track 155, 156, 161 to which the magnetic field sensors 153, 154, 157, 158, 159, 160, 163, 164 and/or the coils are radially arranged to.

In FIG. 1 the channel Ch1 comprises the magnetic field sensor 153 and the magnetic field sensor 154. The channel Ch1 also comprises the at least one coil of the magnetic field sensors 153, 154.

Thus, the channel Ch1 refers to the magnetic field sensor 153, 154.

The channel Ch1 refers to the magnetic track 155. The magnetic field sensors 153, 154 which communicate with the channel Ch1 are arranged radially relative to the magnetic track 155 to which the channel Ch1 refers to as well.

The second channel Ch2 refers to the magnetic track 156. The magnetic field sensors 157, 163 which communicate with the channel Ch2 are arranged radially relative to the magnetic track 156 to which the channel Ch2 refers to as well.

FIG. 2 shows the configuration of FIG. 1 differing in that the ferromagnetic component 1 has an additional magnetic track 161. Therefore in FIG. 2 there are three magnetic tracks 155, 156, 161 arranged next to each other on the ferromagnetic component 1.

In FIG. 2 an additional channel Ch3 is added relative to the configuration of FIG. 1. The third channel Ch3 of the FIG. 2 refers to the magnetic track 161.

The third channel Ch3 refers to the magnetic track 161. The magnetic field sensors 158, 159 which communicate with the channel Ch3 are arranged radially to the magnetic track 161 to which the channel Ch3 refers to as well.

FIG. 3 shows an example of how to combine a tri-band configuration into two channels Ch1 and Ch2. Ch1 is comprised of sensing elements 153, 154, 157 and 163 corresponding to similarly polarized magnetic tracks 161, 155. Ch2 comprises magnetic sensing element 160, 158, 159 and 164.

Each magnetic field sensor 153, 154, 163, 157, 158, 159 refers to the individual magnetic track 155, 156, 161 to which the individual magnetic field sensor 153, 154, 163, 157, 158, 159 is arranged radially, relative to the ferromagnetic component 1, respectively.

Correspondingly, the channels Ch1, Ch2 referring to the magnetic field sensor 153, 154, 157, 163, 158, 159, 160, 164 communicate with the coils of the magnetic field sensor 153, 154, 157, 163, 158, 159, 160, 164 respectively.

### EMBODIMENTS

As already indicated, there are at least the following embodiments, as described below:

Within each of the embodiments, each magnetic field sensor comprises at least one coil.

Each of said coils of said specific magnetic field sensor corresponds to the individual magnetic track to which said specific magnetic field sensor refers to.

Within all of the embodiments of the invention the channels comprise at least one magnetic field sensor, wherein the magnetic field sensors comprise at least one coil.

To generate a signal the magnetic field sensor and/or the coils of the magnetic field sensor communicate with at least one magnetic track.

To form the channel the magnetic field sensor and/or its coils communicate with the magnetic track to which the magnetic field and/or the coils are radially arranged to.

### First Embodiment

The magnetoelastic sensor device comprises a longitudinally extending shaft like member. On this member two magnetic tracks with different polarity are applied. This member is named ferromagnetic component.

In the first embodiment there are two channels related to the ferromagnetic component.

Each channel is generated by the interactions of one magnetic field sensor with one of the magnetic tracks.

Each magnetic field sensor has two coils.

In the first embodiment the coils, which are connected to form the corresponding chamber are arranged radially relative to the magnetic track which corresponds to the magnetic field sensor.

The sensor receives the information emanation from the stress applied to the longitudinally extending shaft like member and its influence on the magnetization of the magnetized tracks according to well-known principles.

In the first embodiment each channel outputs a signal. This signal is generated by the pair of coils of the magnetic field sensor which are arranged radially to the magnetic track and which form the centre of the corresponding channel.

Each individual signal of the respective channel generates information which refers to the respective magnetic track. The information received by the individual channel depends on the composition of the individual coils of each channel.

In the first embodiment the composition of the coils show two coils per each magnetic track referring to the one sensor.

The two coils of said one sensor are arranged radially adjacent relative to the corresponding individual magnetic track.

In the first embodiment differences between the respective signals generated by the individual channel, respectively are identified.

The signal generated by the individual channel refers to the individual magnetic track and the coils of the magnetic field sensor, arranged radially relative to said magnetic track.

After the measurements performed by both channels the results of the measurements are correlated and existing differences between the signals of the channels are settled. After the settlement of the difference of the channels the signals of the channels will coincide.

In the first embodiment the information which is received by the channel depends on the configuration of the individual coils of the individual sensor of the individual channel. Thus the information refers to the individual magnetic track to which the coils of the sensor are radially arranged.

The first embodiment differs from the closest state of the art in that the individual channels refer to the magnetic tracks and the corresponding sensors which are arranged radially to each other. Thus, the channel communicates with the at least one sensor which is arranged radially spaced relative to the magnetic track, which communicates with said channel.

### Second Embodiment

Again also this embodiment comprises a longitudinally extending shaft like member. It is also named ferromagnetic component. The second embodiment shows a ferromagnetic component having three magnetic tracks arranged adjacent to each other and each magnetic track having a different polarity compared to its neighbor track.

The magnetic tracks are arranged in a tri-band arrangement. The tri-band arrangement comprises two outer magnetic tracks. Said two outer magnetic tracks are positioned at either side of one middle magnetic track.

In the second embodiment there are three channels. Each channel comprises at least one magnetic field sensor.

Each magnetic field sensor of the individual channel of the tri-band arrangement is made up of at least one sensor.

In the second embodiment each of the three magnetic tracks has one channel assigned to it.

The center magnetic track has at least one magnetic field sensor radially arranged to it.

Both of the adjacent outer magnetic tracks each have at least one magnetic field sensor arranged radially relative to the respective magnetic track.

Each of the magnetic field sensors arranged radially to the respective track of the tri-band arrangement comprise at least two coils.

Thus, at least one sensor and the corresponding at least two coils of said sensor are arranged radially to the corresponding magnetic track of the tri-band composition.

The sensor receives the information emanation from the stress applied to the longitudinally extending shaft like member and its influence on the magnetization of the magnetized tracks according to well-known principles.

Comparable to the first embodiment each of the channels of the tri-band arrangement outputs the individual signal received.

The signal of the channel referring to the center magnetic track is generated by the coils of the sensor which is arranged radially relative to the center magnetic track.

Also, the signal of the respective outer magnetic track is created by the at least one sensor and its at least two coils which are arranged radially to the respective outer magnetic track.

The signals created by the individual channels of the three magnetic tracks of the tri-band arrangement are compared to each other as described for the first embodiment.

The information received by the individual channels of the tri-band composition are dealt with similar to the first embodiment.

Contrary to the prior art the second embodiment does not connect at least two sensors axially relative to the ferromagnetic component. Thus, the coils comprised in said two sensors are not linked to each other axially relative to the ferromagnetic component.

Opposite to the prior art the at least two coils of one sensor and the sensor itself refer to the magnetic track to which the sensor and the coils are arranged axially relative to the ferromagnetic component. This is the case independent of the number of magnetic tracks arranged on the ferromagnetic component.

### Third Embodiment

Again also this embodiment comprises a longitudinally extending shaft like member.

The third embodiment shows a ferromagnetic component having three magnetic tracks arranged adjacent to each other.

Parallel to the second embodiment the ferromagnetic component has three magnetic tracks which are arranged adjacent to each other and each magnetic track having a different polarity compared to its neighbor track.

Whereas the magnetic tracks are arranged in a tri-band arrangement, contrary to the second embodiment at least two magnetic tracks form the basis for one common channel.

In the following the assumption is made that two outer magnetic tracks form the basis of the one common channel.

Thus, the center magnetic track is the basis for the second channel.

Parallel to the second embodiment the individual channel each comprises at least two sensors.

Each of said sensors comprises at least two coils.

The magnetic tracks of the tri-band arrangement shown in the third embodiment comprise at least four magnetic field sensors. Each of said four magnetic field sensors can have any numbers of magnetic tracks and magnetic field sensing elements Any number of sensing elements can be used to define a working sensor system or individual channel.

The sensors and said associated coils of the third embodiment which are arranged radially to both of the outer magnetic tracks, are combined to form a common channel.

The sensor receives the information emanation from the stress applied to the longitudinally extending shaft like member and its influence on the magnetization of the magnetized tracks according to well-known principles.

The channel referring to the center magnetic track comprises the same number of sensors and also the same number of associated coils as the common channel, which refers to the two outer magnetic tracks.

Comparable to the first and the second embodiment each of the at least two channels of the third embodiment creates an individual signal.

The signal of the first channel however is created by the coils of the sensor associated both to the first and the second outer magnetic tracks.

The second signal is created by the total number of sensors and by the total number of coils of the common channel, arranged radially relative to the center magnetic track.

The signal of the first channel of the third embodiment relating to the outer magnetic tracks is compared to the signal which is created by the center magnetic track.

In the third embodiment both channels refer to the same number of sensors and the same number of coils.

The arrangement of the third embodiment differs from the first and the second embodiment in that the number of sensors and the number of the corresponding coils of the center magnetic track corresponds with the number of sensors and corresponding coils, corresponding to the individual channels, forming the second channel.

In the third embodiment the number of sensors and the corresponding number of coils forming the channel referring to the center magnetic track is distributed over the two outer magnetic tracks.

Thus the number of sensors and the number of the corresponding coils leading to the first channel is spread over the first and the second outer magnetic tracks.

Each of the channels of the third embodiment outputs an individual signal.

Differences between the signals which are created through the measurement of the individual channels can be settled.

The settlement of the signals can be performed mathematically or by any other means, as is the case with the first and second embodiment.

After the settlement of the signals of the corresponding channels the signals of the channels referred to in the respective embodiment coincide.

The information which is received by the measurements performed by the individual channels depends on the composition of the individual coils of the corresponding magnetic field sensors which are arranged radially to the corresponding magnetic field.

The number of coils which are part of the channel are configured and combined individually.

The coils of said sensors are split into sets of individual coils. It goes without saying that the number of coils can be an even number or odd number.

If the information of one or more of the same magnetic tracks is required to generate the signal of the at least two channels in the state of the art the sensors of two individual channels would be combined axially relative to the ferromagnetic component.

The two individual sensors of the two individual channels are connected with each other in such a manner that at least one sensor of each channel communicates with the same magnetic track.

If the information of one or more of the same magnetic tracks is required to generate the signal of the at least two channels the invention reveals that two individual channels which are formed by at least one sensor spaced radially to one specific magnetic track are combined to form one common channel.

The assumption is made that the individual channels—for reasons of simplicity—also referred to as “channels” are linked with each other to form the common channel. The individual channels can be arranged on the ferromagnetic component next to each other. It goes without saying that at least two individual channels which are linked with each other to form the common channel can be spaced by at least one other channel.

### Fourth and More Embodiments

In the fourth and in any further embodiment single or multiple magnetized tracks can be arranged on a ferromagnetic component some of which can be un-magnetized.

The further proceeding corresponds to that described with regard to the embodiments 1 to 3 listed above.

Detailed description of the components of the magnetoelastic sensor device

Ferromagnetic Component

The magnetoelastic sensor device comprises a longitudinally extending shaft like member.

Typically, the component consists of an at least partially ferromagnetic, magnetoelastically suitable material.

According to the invention, the component signifies a preferably elongated body, for example a cylindrical body, a conically tapering body or a wave-shaped body. The component may also have a staircase-shaped configuration or any other suitable configuration to measure the required stresses.

In any case, the body may at least partially be provided with or made of a ferromagnetic material. Hardening steel containing nickel (Ni) or chrome (Cr) is particularly suitable as such a ferromagnetic material. However, it shall be understood that other ferromagnetic materials may likewise be used.

The component may preferably be configured in the form of a shaft, in particular a drive shaft.

Preferably, the component is arranged in any device or craft, for example aircraft, a land craft or a watercraft. In addition, the component can, for example, also be used in an industrial facility or a household appliance.

The component has a magnetizable region.

Magnetic Track

This invention will work with single magnetic tracks and all other additional tracks may or may not be magnetized. According to the invention, in the case that the magnetisation occurred, the component has a region which comprises preferably two or three or more magnetic tracks opposing each other, which, for the sake of simplification, are also referred to below by way of example as “dual-band magnetization”, “tri-band magnetisation” or “multiple-band magnetization”.

The arrangement of three magnetic tracks opposing to each other represents an advantageous combination of two dual-band magnetic tracks. The combination of the two dual-band magnetic tracks is achieved by mirroring the dual-band array and by jointly using the middle track. This has the effect that the respectively inner track has the same positive or negative polarisation.

This has the advantage that one magnetic track can be omitted and thus a spatial combination of the magnetic tracks can be provided so that a more uniform mapping of measurement results can be achieved in this way and less axial installation space is required.

The component has at least three circumferential magnetic tracks (tri-band) with magnetisations opposing each other.

In case of a tri-band magnetisation, the magnetic track which is spatially arranged on the left is, for example, magnetised positively, the middle magnetic track negatively and the right magnetic track positively again, and vice versa.

The number of magnetic tracks with a magnetisation opposing the adjacent magnetic track may, however, also be increased.

The magnetisation of the individual magnetic tracks may take place simultaneously or in a time-delayed manner.

Magnetic Field Sensor

The magnetic field sensor is a highly sensitive measuring devices for detecting extremely small magnetic fields.

The magnetic field sensors preferably work on a fluxgate basis. The fluxgate sensor is a highly sensitive measuring device for detecting extremely small magnetic fields.

Hall sensors, for example, can also be used as magnetic field sensors in the sense of the present invention.

It should be noted however that any suitable type of magnetic field sensors can be used according to the invention.

Insofar as there is talk of a coil within the framework of the invention, here this is preferably a wire winding with an amorphous core which is used as a measuring coil. The coils are therefore arranged axially (parallel) within the magnetic field sensor and radially to the magnetic track of the ferromagnetic component in such a manner that they preferably can detect both product-related magnetic fields produced by application of stress and also external magnetic fields possibly produced by interference effects.

However, the magnetic field sensor can be configured so that is can distinguish different magnetic fields from one another.

The magnetic field sensor receives at least one signal due to the coils and evaluates this, optionally whilst transmitting to a separate display unit.

According to the disclosure, the magnetic field sensor and the corresponding coils are connected radially in relation to the corresponding magnetic track.

Coils

The magnetic field sensor comprise at least two coils. All coils refer to individual magnetic field sensors. Both the magnetic field sensor and the coils which are arranged radially relative to one specific magnetic track are part of the channel referring to said magnetic track.

The coils of each magnetic field sensor correspond to the magnetic tracks to which the individual magnetic field sensor radially refers.

The magnetic field sensors and the magnetic coils are arranged at a radial distance to the ferromagnetic component.

Any information which is received by the measurements made by the channels depends on the composition of individual coils making up the individual channel.

Depending on the configuration of the coils individual channels generate different information. The number of coils can both take an even number and an odd number.

In relation to the magnetic track arranged on the ferromagnetic component said coils are connected radially.

The coils which are connected to form a channel are arranged radially relative to the magnetic track which corresponds to the magnetic field sensor.

The coils form a sensor of a tri-band-configuration and/or a dual-dual-band configuration.

The coils can be split into sets of at least two individual coils. In goes without saying that it can also be a set of four or any other number.

The coils are interconnected in any possible form and any relation with each other and in any configuration to form the channel.

A pair of coils brings about a differential balance. Said balance is the sum of the effects of the individual measurement of said coils. At least two magnetic coils are assigned to one (first and second) magnetic field sensor (dual-dual-band magnetization).

The coils of magnetic field sensors (first and second) have a predetermined direction of magnetization. The coils of at least one magnetic field sensors (first or second) can be inverted thus reversing the direction of magnetization of each of the individual coils of said magnetic field sensors (first and second).

Channel and Signal, Generated by the Channel

The composition of a respective channel each comprises at least one magnetic field sensor. The channel is linked with the at least two coils which are associated with the magnetic field sensor of the channel. The channel corresponds with at least one magnetic field sensors, respectively.

Also, the channel comprises the magnetic field sensor. The channel is linked with the coils of the respective magnetic field sensor.

The magnetic field sensor is associated radially with one specific magnetized track. The channel which comprises the magnetic field sensor is associated radially with the magnetic track which is associated radially with the magnetic field sensor.

Thus, with all three embodiments discussed above each magnetic field sensor refers to one individual magnetic track of the ferromagnetic component, respectively.

Correspondingly, the channel referring to a specific number of magnetic field sensors communicates with those coils which are associated with the magnetic field sensor.

Thus each channel is formed per magnetic track, instead of across two magnetic tracks. The individual channels are connected with each other by wiring.

The channel outputs a signal.

To generate the channel at least one magnetic field sensor can be combined with at least two coils.

Differences between the signal of the measurement made by one channel and signal of the measurement made by another channel are settled mathematically.

After the measurements done by both channels the arising difference signal between the two channels can be settled. After the settlement the signals between both channels coincide.

The fact that channel is made of at least two sensors, each of which comprises at least two coils can be applied to any dual-band or tri-band magnetic track application.

It can even be applied to a single band application to measure the magnetic stress applied to a ferromagnetic component.

According to another aspect of the invention, a common channel is formed by at least two individual channels. The individual channel is the channel referred to in claim 1.

The magnetic field sensors referred to by common channel comprises the magnetic field sensors of the at least two individual channels.

A further aspect of the invention is a method for determining an external magnetic influence, by means of the magnetoelastic sensor device.

A method for determining an external magnetic influence may comprise the following steps:
magnetization of a component, comprising at least one ferromagnetic material; and
generating at least one magnetizable track on the component having a defined direction of the magnetization. At least one magnetic field sensor and at least one corresponding coil for forming an individual channel is provided.

In accordance with an aspect of the method, the at least one magnetic field sensor and at least one corresponding coil of each magnetic field sensor are set in relation with each other axially along the direction of a magnetization of the assigned magnetizable track.

In accordance with another aspect of the method, the at least one magnetizable track of the component are measured with the at least one sensor and/or the at least one corresponding coil per individual channel.

In accordance with another aspect of the method, a signal is generated resulting from the measurement of the individual channel.

In accordance with another aspect of the method, the determination of a presence of a magnetic noise in the signal emanated by the individual channel.

In accordance with another aspect of the method, at least one of the individual channels are balanced to cancel the noise, present in the signal.

Also another aspect is the use of the device for determining an external magnetic influence, comprising a component. The component consists of an at least partially of ferromagnetic material. A magnetisable region comprising at least three opposing magnetic tracks. The at least three magnetic tracks are arranged axially in relation to the component. A first magnetic field sensor with at least two coils for emitting a signal is arranged radially in relation to the component is assignable to the each one of the two magnetisable tracks.

### Example

The magneto elastic sensor device, named above magnetic field sensor, is further explained by way of the following example, whereby the magneto elastic sensor device is a torque, force or other load sensor using a solid or hollow shaft or any other magnetostrictive geometry as the load carrying member.

The invention is, however, not restricted to a configuration of this example.

The load member is usually magnetised in one or more locations axially with opposing orientation though this invention will also work with a single magnetisation band.

Positioned close to each magnetic band are one or more magnetic field sensors.

Magnetic field sensor pairs are positioned adjacent to one another or positioned diametrically apart as in FIG. 1

The magnetic field sensors on each band detect magnetic flux from the environment and the magnetic flux produced from the shaft through the magnetoelastic effect.

The magnetic sensor orientations are such that they can produce common signal or differential signals in the presence of a magnetic flux.

The signals produced by the sensors associated with each magnetic band form individual signal channels shown in FIG. 1 as channel Ch1 and channel Ch2.

The sensing elements for each channel Ch1, Ch2 are radially positioned rather than axially as in prior art. This is seen in FIG. 1 where channel Ch1 is made from a magnetic track 155 and magnetic field sensors 153 and 154. Similarly, the channel Ch2 is made from magnetic track 156 and magnetic field sensors 157, 163.

A Sensor channel Ch1, Ch2 configured in such a way is used to measure the magnetic flux from the magnetoelasitc effect, common mode fields and near field effects.

Each channel Ch1, Ch2 is calibrated individually such that the channels Ch1, Ch2 are closely matched.

By way of example the transducer transfer function ChxmV/Nm defines the sensor output voltage as a function of torque. Through calibrating the transfer functions associated with each band measurement are closely matched. Thus giving this method a performance advantage of the state of the art.

When Vn1 is the common mode noise field contribution from the combined sensing elements, and Vn2 are set to be sensing elements, it is assumed that ΔVn1-n2=Vn1−Vn2.

However, in prior art combined magnetic tracks do not compensate for ΔVn1-n2 since the methods known from prior art use axially separated sensing elements across more than one magnetic tracks.

No improved noise immunity is achieved unless all the complete assembly variables are perfectly matched, including the sensing elements and all manufacturing and assembly tolerances that affect the final measurement of the sensing element.

Thus, when Vs1 and Vs2 values are perfectly matched in the presence of a common mode field a ΔVn1-n2 will be zero.

This give a high signal to noise ratio which is essential in the measurement of weak signal magnetic fields in the presence of relatively large noise fields.

The channels are calibrated to reject diverging fields such as known near fields or unbalanced common mode fields due to magnetically unbalanced geometries surrounding the measurement point.

The following assumptions are made:

The signals Vch1 and Vch2 imply that Vn1 and Vn2 are the noise fields and Vs1 and Vs2 are the signal fields. The same applies to a signal Vch3 with Vn3 and Vs3. Thus:

Vch1=Vs1+Vn1

Vch2=Vs2−Vn2

A correction factor is calculated as: Kn=Vch1/Vch2 in the presence of a zero signal.

Hence: when this correction factor is applied to Vch2

Vout=Vs1+Vn1+Kn*Vs2−Vn1

Vout=Vs1+Kn*Vs2

The above equations show the presence of signal and no noise field errors.

The Ratio Kₙ being a measurement leads to the fact that all tolerances are removed.

FIG. 3 shows an example of multimode sensing using a tri-band configuration.

FIG. 3 shows the channel Ch1 comprising four sensing elements 153, 157, 154, 163, whereas the channel Ch2 is comprised of the sensing elements 160, 158, 159, 164.

The variety of sensor configurations gives the opportunity to reject very high S/N ratios of both common mode and near fields at the same time.

In the case of FIG. 2 when a three channel configuration with the channels Ch1, Ch2 and Ch3 is used the signals can be combined to obtain the same performance as in a situation with deals with a common mode fields and near field stress.

FIG. 2 provides additional information regarding the noise gradient referring to the sensing elements. The additional information is essential to accumulate a more accurate prediction of a potential non-linear near field disturbance.

For multimode sensing using a tri-band configuration (shown in of FIG. 2) a channel Cha comprises the sensing elements 153, 154, whereas another channel Chb refers to the sensing elements 157, 163. A third channel Chc refers to the sensing elements 158, 159.

A similar configuration reveals a channel Ch1, comprising (Cha+Chc)/2 and Ch2 is Chb.

The sensor topology independently rejects very high S/N ratios of common mode fields.

In a configuration showing three channels Ch1, CH2 and CH3 the signals are combined to obtain cancellation of both common mode fields and near fields. Additionally, information regarding the noise gradient referring to the respective sensing elements can be obtained. This additional information supplies a more accurate prediction of a potential non linear near field disturbance.

According to the assumptions above, the statement is made that:

Magnetic track 155 measures Vs1 and Vn1

Magnetic track 156 measures Vs2 and Vn2

Magnetic track 161 measures Vs3 and Vn3

Vch1=Vs1+Vn1

Vch2=Vs2-Vn2

Vch3=Vs3+Vn3

Correction factors are:

Kn1=Vch2/Vch1

Kn3=Vch2/Vch3

Vout=(Kn1*Ch1+Ch2)/2+(Ch2+Kn3*Ch3)/2

Vn1, Vn2 and Vn3 are cancelled leaving only the signal content.

Additionally, the noise gradient and direction through the sensing area of the system is assumed to be: VΔn=(Kn1*VCh1-Kn3*Vch3)/2.

### DESCRIPTION OF THE FIGURES

Further aspects and features are set forth in the following description of preferred embodiments according to FIGS. 1 to 6.

FIG. 1 shows the schematic view of two individual magnetic field sensors, wherein each magnetic field sensor refers to one individual magnetic track of a ferromagnetic component;

FIG. 2 shows the configuration of FIG. 2, showing three magnetic tracks instead of two magnetic tracks;

FIG. 3 shows the configuration of FIG. 2 with a different arrangement of magnetic field sensors;

FIG. 4 shows one aspect of the prior art;

FIG. 5 shows another aspect of the prior art; and

FIG. 6 shows a similar configuration as FIG. 3, having a different arrangement of the magnetic field sensors.

### DETAILED DESCRIPTION

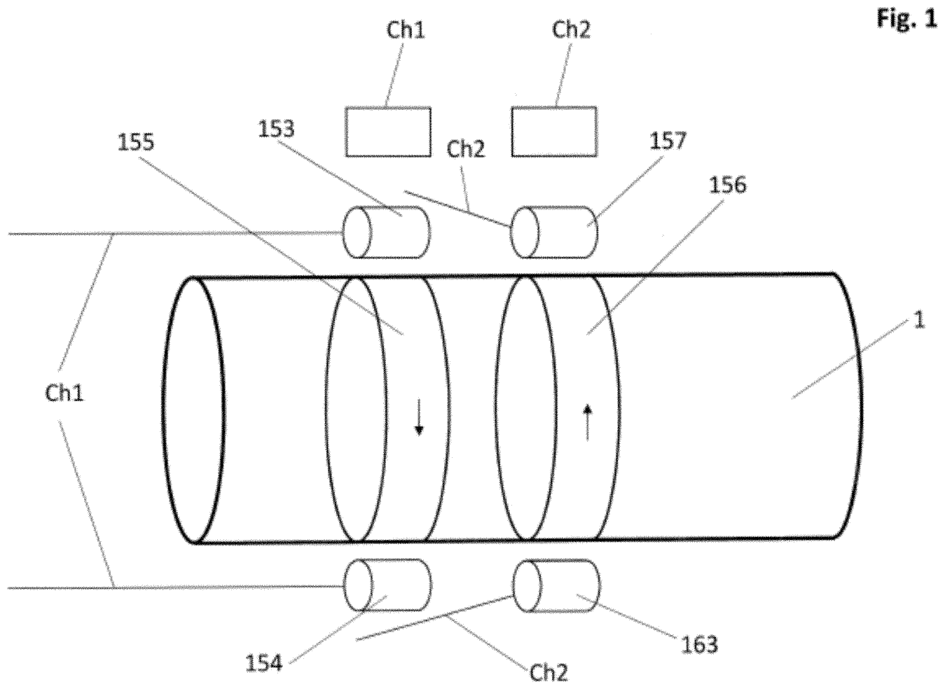

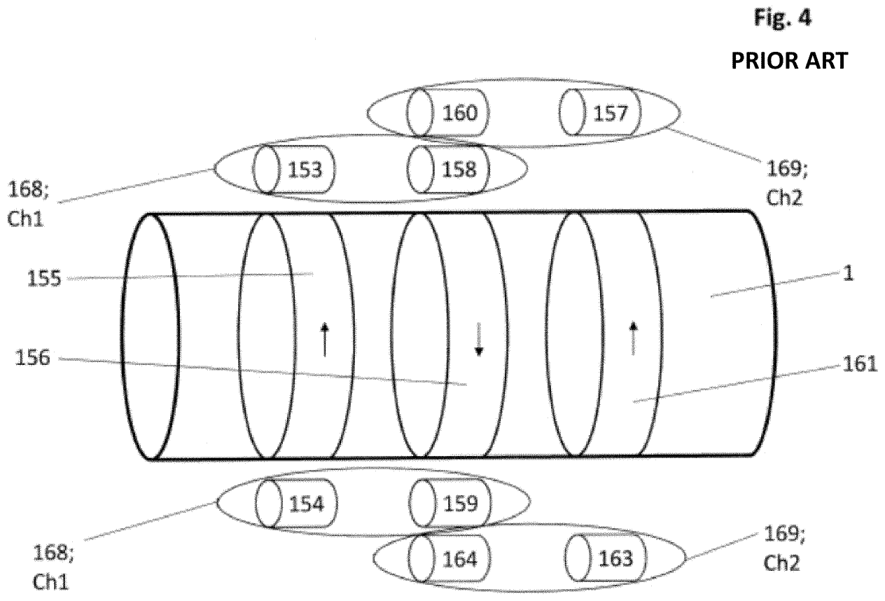

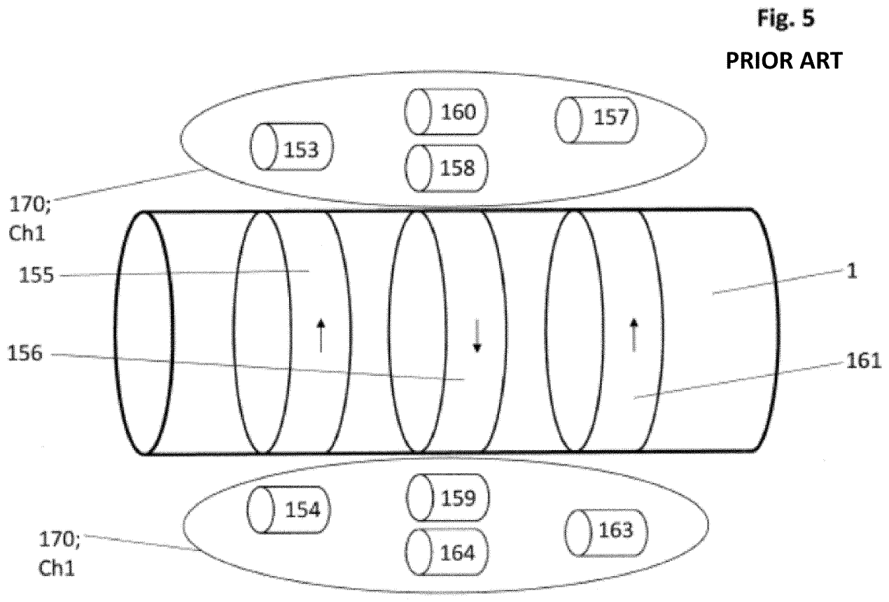

The FIGS. 1 to 3 and FIG. 6 show the differences of the invention relative to the prior art, shown in FIG. 4 and FIG. 5.

In the FIG. 1 the channel Ch1 comprises the magnetic field sensor 153 and the magnetic field sensor 154. The channel Ch1 also comprises the at least one coil of the magnetic field sensors 153, 154. The coils of the magnetic field sensors 153, 154 are not shown in FIG. 1.

Thus, the channel Ch1 referring to the magnetic field sensor 153, 154 communicates with the coils of the magnetic field sensors 153, 154.

The channel Ch1 refers to the magnetic track 155. The magnetic field sensors 153, 154 which communicate with the channel Ch1 are arranged radially relative to the magnetic track 155 to which the channel Ch1 refers to as well.

The second channel Ch2 refers to the magnetic track 156. The magnetic field sensors 157, 163 which communicate with the channel Ch2 are arranged radially relative to the magnetic track 156 to which the channel Ch2 refers to as well.

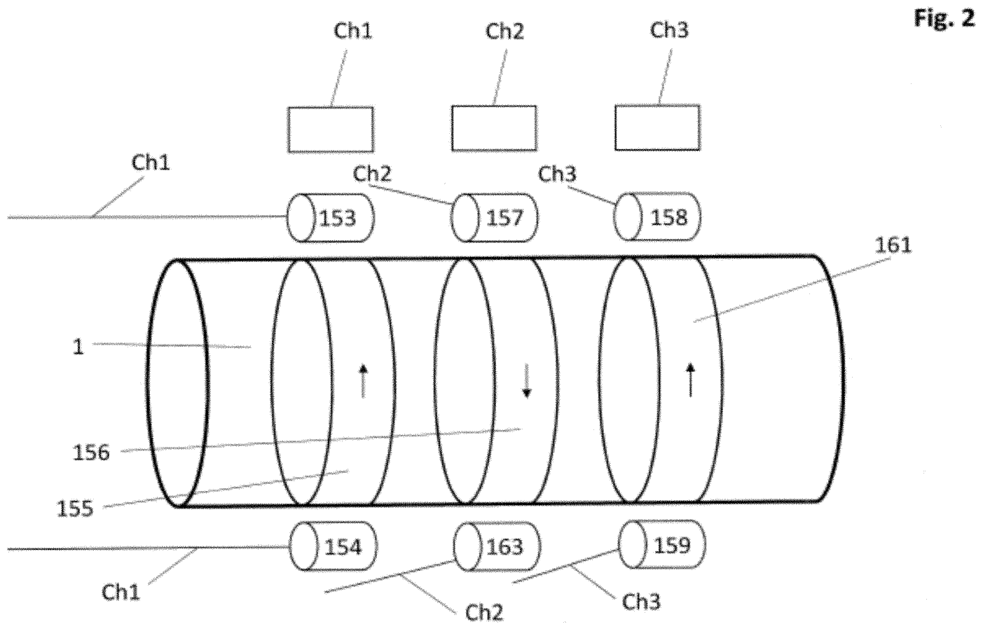

FIG. 2 shows the configuration of FIG. 1 differing in that the ferromagnetic component 1 has an additional magnetic track 161. Therefore in FIG. 2 there are three magnetic tracks 155, 156, 161 arranged next to each other on the ferromagnetic component 1.

In FIG. 2 an additional channel Ch3 is added relative to the configuration of FIG. 1. The third channel Ch3 of the FIG. 2 refers to the magnetic track 161.

The magnetic field sensors 158, 159 which communicate with the channel Ch3 are arranged radially to the magnetic track 161 to which the channel Ch3 refers to as well.

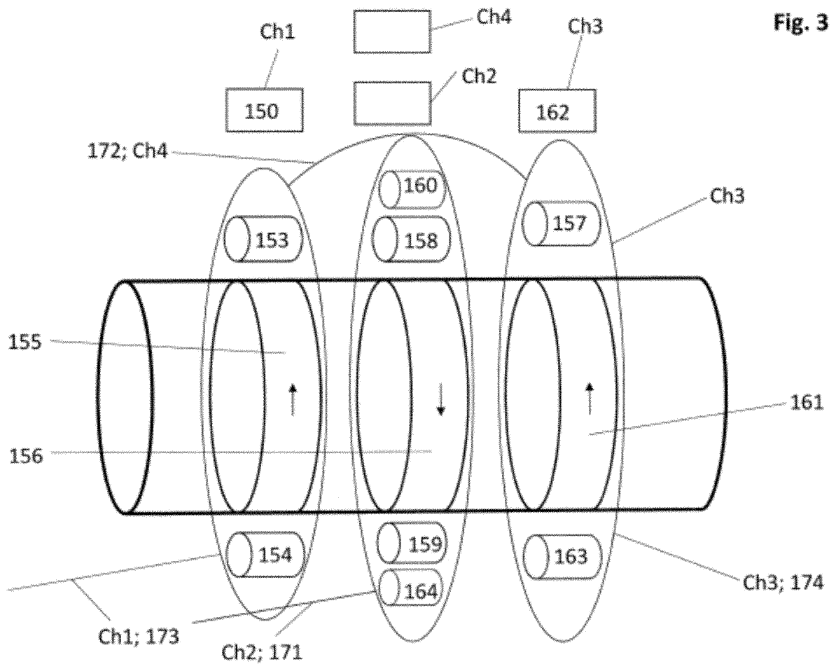

FIG. 3 shows a configuration displaying three channels Ch1, Ch2, Ch3. In the FIG. 3 each of the channels Ch1, Ch2, Ch3 corresponds with at least two of the magnetic field sensors 153, 154, 157, 163, 158, 159, 160, 164 respectively.

Channel Ch1 is associated with the magnetic field sensors 153, 154, whereas the third channel Ch3 is associated with the magnetic field sensors 157, 163.

The channel Ch2 is associated with the magnetic field sensors 158, 159, 160 and 164.

Therefore, the channel Ch2 has two additional magnetic field sensors 160 and 164. Thus, the channel Ch2 not only refers to the magnetic field sensors 158 and 159 but also to the additional magnetic field sensors 160 and 164.

Each of the magnetic field sensors 153, 154, 157, 163, 158, 159, 160, 164 and related coils associated with the corresponding channel Ch1, Ch2, Ch3 refers to the magnetic track 155, 156, 161 of the ferromagnetic component 1 to which the relevant channel Ch1, Ch2, Ch3 corresponds to.

In other words, the channel Ch1 is associated with the magnetic field sensors 153, 154 and refers to the magnetic track 155. The channel Ch2 is associated with the magnetic field sensors 158, 159, 160 and 164 and refers to the magnetic track 156. The channel Ch3 is associated with the magnetic field sensors 157, 163 and refers to the magnetic track 161.

In FIG. 3 the two outer channels Ch1 and Ch3 form one common channel Ch4. The common channel Ch4 refers to the magnetic tracks 155, 161.

Thus, the common channel Ch4 refers to the individual magnetic field sensor 153, 154, 163, 157 which refer to the magnetic tracks 155, 161. Any two or more of the channels Ch1, Ch2, Ch3 can be combined to form the common channel Ch4. Also, the common channel can be formed of any two or more magnetic field sensors 153, 154, 157, 163, 158, 159, 160, 164 and corresponding coils of said sensors.

In other words, the common channel Ch4 refers to the individual magnetic field sensor 153, 154, 163, 157 which are arranged radially relative to both the magnetic tracks 155 and 161.

The signals generated by the common channel Ch4 is compared to the signal generated by the channel Ch2, referring to the center magnetic track 156 which communicate with four magnetic field sensors 158, 159 and 160 and 164.

In FIG. 3. the number of the coils of the individual magnetic field sensors 153, 154, 163, 157 are also referred to by the common channel Ch4.

In FIG. 3 the ellipse 171 represents the channel Ch2. The ellipses 172 represents the channel Ch4 comprising the magnetic field sensors 153, 154, 157, 163, 158, 159, 160, 164 and corresponding coils of the individual channels Ch1 and Ch3.

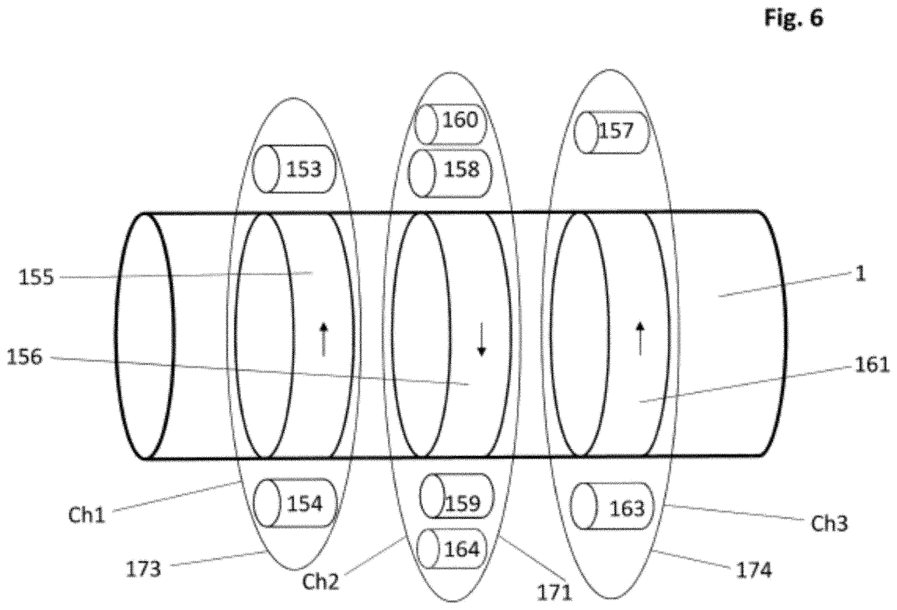

FIG. 6 shows a configuration displaying three channels Ch1, Ch2, Ch3. In the FIG. 6 each of the channels Ch1, Ch2, Ch3 corresponds with at least two of the magnetic field sensors 153, 154, 157, 163, 158, 159, 160, 164 respectively.

Channel Ch1 is associated with the magnetic field sensors 153, 154, whereas the third channel Ch3 is associated with the magnetic field sensors 157, 163.

The channel Ch2 is associated with the magnetic field sensors 158, 159, 160 and 164.

Therefore, the channel Ch2 has two additional magnetic field sensors 160 and 164. Thus, the channel Ch2 not only refers to the magnetic field sensors 158 and 159 but also to the additional magnetic field sensors 160 and 164.

Each of the magnetic field sensors 153, 154, 157, 163, 158, 159, 160, 164 and related coils associated with the corresponding channel Ch1, Ch2, Ch3 refer to the magnetic track 155, 156, 161 of the ferromagnetic component 1 to which the relevant channel Ch1, Ch2, Ch3 corresponds to.

In other words, the channel Ch1 is associated with the magnetic field sensors 153, 154 and refers to the magnetic track 155. The channel Ch2 is associated with the magnetic field sensors 158, 159, 160 and 164 and refers to the magnetic track 156. The channel Ch3 is associated with the magnetic field sensors 157, 163 and refers to the magnetic track 161.

In FIG. 6 the ellipses 173 represents the channel Ch1, whereas the ellipse 171 represents the channel Ch2 and ellipse 174 representing the channel Ch3.

FIG. 6 shows three individual channels Ch1, Ch2 and Ch3. The signals generated by the individual channels Ch1, Ch2 and Ch3 are compared to each other.

### REFERENCE NUMERALS

1 ferromagnetic component
Ch1 Channel A
Ch2 Channel B
153 Magnetic field sensor A1
154 Magnetic field sensor A2
155 Magnetic track A
156 Magnetic track B
157 Magnetic field sensor A3
158 Magnetic field sensor B1
159 Magnetic field sensor B2
160 Magnetic field sensor B3
161 Magnetic track C
Ch3 Channel C
163 Magnetic field sensor A4
164 Magnetic field sensor B4
Ch4 Common channel
166
167
168 Ellipse
169 Ellipse
170 Ellipse
171 Ellipse
172 Ellipse
173 Ellipse
174 Ellipse

1. A magnetic field sensor device for determining an external magnetic influence, comprising:
a component formed with an at least partially ferromagnetic material, the component having a magnetisable region comprising at least two magnetizable tracks which are arranged adjacent to each other, the magnetizable tracks having opposing directions of magnetization, the at least two magnetizable tracks being arranged axially in relation to the component;
a first magnetic field sensor comprising at least one coil, the first magnetic field sensor being arranged radially in relation to the component, the first magnetic field sensor being adapted and configured for detecting magnetic information from at least one of environment in which the magnetic field sensor device is exposed and the component, the first magnetic field sensor being adapted and configured for emitting a first signal, the first magnetic field sensor being assignable to at each of the least two magnetizable tracks of the component;
a second magnetic field sensor comprising at least one coil, the second magnetic field sensor being arranged radially in relation to the component, the second magnetic field sensor being adapted and configured for detecting magnetic information from at least one of environment in which the magnetic field sensor device is exposed and the component, the second magnetic field sensor being adapted and configured for emitting a second signal, the second magnetic field sensor being assignable to each of the at least two magnetizable tracks of the component;
wherein the first signal of the first magnetic field sensor is set in relation to the second signal of the second magnetic field sensor;
wherein the second signal of the second magnetic field sensor is set in relation to the first signal of the first magnetic field sensor;
wherein the first and second signals produced by the respective magnetic field sensors assigned to each of the at least two magnetizable tracks of the component form at least one individual signal channel;
wherein the first magnetic field sensor and the second magnetic field sensor are arranged in a manner such that the at least one coil of the corresponding magnetic field sensor are set in relation with each other axially along the direction of magnetization of the magnetic track of the component assigned to the magnetic field sensor to form the at least one individual signal channel.

2. A magnetic field sensor device according to claim 1, characterised in that the magnetic field sensors for the at least one individual signal channel are positioned radially relative to the component.

3. A magnetic field sensor device according to claim 1, characterised in that the magnetic field sensors for the at least one individual signal channel are positioned in the proximity of the component.

4. A magnetic field sensor device according to claim 1, characterised in that the at least one magnetic field sensor is adapted and configured to produce a common signal of differential signals of a magnetic flux.

5. A magnetic field sensor device according to claim 1, characterised in that a common channel is formed by at least two individual channels.

6. A magnetic field sensor device according to claim 1, characterised in that the least one individual signal channel can be calibrated individually.

7. A magnetic field sensor device according to claim 1, characterised in that each individual channel is adapted and configured to measure magnetic flux resulting from at least one of a magnetoelastic effect, a common mode field effect, and a near field effect.

8. A magnetic field sensor device according claim 1, characterised in that the at least one individual signal channel is adapted and configured to reject a common mode field effect.

9. A magnetic field sensor device according to claim 1, characterised in that the at least one individual signal channel is adapted and configured to be calibrated to reject diverging fields or unbalanced common mode fields.

10. A method for determining an external magnetic influence, comprising:
magnetizing a component wherein the component comprises at least partially ferromagnetic material;
generating at least two magnetizable tracks on the component, the at least two magnetizable tracks having opposing directions of the magnetization;
providing at least two magnetic field sensors, each magnet field sensor having at least one corresponding coil, each magnet field sensor being adapted and configured to emit a signal;
arranging the at least two magnetic field sensors in a manner such that the at least one coil of the corresponding magnetic field sensor are set in relation with each other axially along the direction of magnetization of the magnetizable track of the component assigned to the magnetic field sensor;
measuring magnetic flux of the at least one magnetizable track of the component with the at least one magnetic field sensor to form an individual signal channel;
generating a signal resulting from the measurement of the individual signal channel;
determining a presence of a magnetic noise in the individual signal channel; and
balancing the at least one individual signal channel to cancel the noise present in the signal.

11. The method according to claim 10, characterized in that the component comprises a dual-dual band configuration.

12. The method according to claim 10, characterized in that the component comprises a tri-band configuration.

13. A device for determining an external magnetic influence, comprising:
a component formed at least partially of ferromagnetic material, the component having a magnetizable region comprising at least three magnetic tracks, the at least three magnetic tracks being arranged axially in relation to the component;
a first magnetic field sensor with at least two coils, the first magnetic field sensor being arranged radially in relation to the component, the first magnetic field sensor being assigned to the first and second magnetic tracks of the component, the first magnetic field sensor being adapted and configured for emitting a first signal;
a second magnetic field sensor with at least two coils, the second magnetic field sensor being arranged radially in relation to the component, the second magnetic field sensor being assigned to the second and third magnetic tracks of the component, the second magnetic field sensor being adapted and configured for emitting a second signal;
wherein the first signal of the first sensor is adapted and configured to be set in relation to the second signal of the second sensor; and
wherein the second signal of the second sensor is adapted and configured to be set in relation to the first signal of the first sensor.
